(19) United States
(12) Patent Application Publication
(10) Pub. No.: US 2025/0080555 A1
(43) Pub. Date: Mar. 6, 2025

(54) THREAT ANALYSIS METHOD, THREAT ANALYSIS SYSTEM AND RECORDING MEDIUM

(71) Applicant: Panasonic Automotive Systems Co., Ltd., Kanagawa (JP)

(72) Inventors: Hatsuho AOSHIMA, Osaka (JP); Yusuke NEMOTO, Hyogo (JP); Hiroyuki WADA, Kyoto (JP); Minehisa NAGATA, Osaka (JP)

(73) Assignee: Panasonic Automotive Systems Co., Ltd., Kanagawa (JP)

(21) Appl. No.: 18/953,980

(22) Filed: Nov. 20, 2024

Related U.S. Application Data
(63) Continuation of application No. PCT/JP2023/003579, filed on Feb. 3, 2023.

(30) Foreign Application Priority Data
May 30, 2022 (JP) 2022-087544

(51) Int. Cl. H04L 9/40

(52) U.S. Cl. CPC H04L 63/1416; H04L 63/1441

(57) ABSTRACT

A threat analysis method is a threat analysis method to be executed in a threat analysis system that presents a countermeasure against a threat of a cyberattack on a monitored object based on an analysis result of the cyberattack. The threat analysis method includes: obtaining a threat analysis result after analysis of a threat of a cyberattack on the monitored object; determining a plurality of countermeasures against the threat based on the threat analysis result; determining degrees of recommendation of the plurality of countermeasures determined, based on an adoption database containing adoption results of the plurality of countermeasures from the past; and outputting the plurality of countermeasures determined in association with the degrees of recommendation, and presenting the plurality of countermeasures to a user.

### CROSS REFERENCE TO RELATED APPLICATIONS

This is a continuation application of PCT International Application No. PCT/JP2023/003579 filed on Feb. 3, 2023, designating the United States of America, which is based on and claims priority of Japanese Patent Application No. 2022-087544 filed on May 30, 2022.

### FIELD

The present disclosure relates to a threat analysis method, a threat analysis system, and a recording medium.

### BACKGROUND

Conventionally, analysis of problems on security of mobile entity systems such as in-vehicle systems and measures (countermeasures) to be taken against the problems have been performed in the stage of development of moving entities. Patent Literature (PTL) 1 discloses a device that comprehensively analyses information security risks and presents measures against these.

### CITATION LIST

### Patent Literature

[PTL 1] Japanese Unexamined Patent Application Publication No. 2009-110177

### SUMMARY

However, the relay device according to PTL 1 can be improved upon.

Accordingly, the present disclosure provides a threat analysis method, a threat analysis system, and a recording medium, which are capable of improving upon the above related art.

The threat analysis method according to one aspect of the present disclosure is a threat analysis method to be executed in a threat analysis system that presents a countermeasure against a threat of a cyberattack on a monitored object based on an analysis result of the cyberattack, the threat analysis method including: obtaining a threat analysis result after analysis of the threat of the cyberattack on the monitored object; determining a plurality of countermeasures against the threat based on the threat analysis result; determining degrees of recommendation of the plurality of countermeasures determined, based on an adoption database containing adoption results of the plurality of countermeasures from a past; and outputting the plurality of countermeasures determined in association with the degrees of recommendation, and presenting the plurality of countermeasures to a user.

The threat analysis system according to one aspect of the present disclosure is a threat analysis system that presents a countermeasure against a threat of a cyberattack on a monitored object based on an analysis result of the cyberattack, the threat analysis system including: an obtainer that obtains a threat analysis result after analysis of the threat of a cyberattack on the monitored object; a first determiner that determines a plurality of countermeasures against the threat based on the threat analysis result; a second determiner that determines degrees of recommendation of the plurality of countermeasures determined, based on an adoption database containing adoption results of the plurality of countermeasures from a past; and an outputter that outputs the plurality of countermeasures determined in association with the degrees of recommendation, and presents the plurality of countermeasures to a user.

The recording medium according to one aspect of the present disclosure is a non-transitory computer-readable recording medium having recorded thereon a program for causing a computer to execute the threat analysis method.

According to one aspect of the present disclosure, a threat analysis method and the like capable of improving upon the above related art can be provided.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a functional configuration of the threat analysis system according to an embodiment.

FIG. 2 is a diagram illustrating one example of an asset classification according to the embodiment.

FIG. 3 is a diagram illustrating one example of a threat classification according to the embodiment.

FIG. 4 is a diagram illustrating one example of a control measure DB according to the embodiment.

FIG. 5 is a diagram illustrating one example of an adoption DB according to the embodiment.

FIG. 6 is a flowchart illustrating the operation of the threat analysis system according to the embodiment.

FIG. 7 is a diagram illustrating a flow of a variety of items of data according to the embodiment.

FIG. 8 is a diagram illustrating one example of a provisional control measure according to the embodiment.

FIG. 9 is a diagram illustrating update of a degree of recommendation according to an embodiment.

### DESCRIPTION OF EMBODIMENTS

### Circumstances Leading to the Present Disclosure

Recently, in-vehicle devices within vehicles are connected to an in-vehicle network through a control area network (CAN) or the Ethernet, increasing a variety of communication between in-vehicle devices and devices outside the vehicles through the in-vehicle network. The in-vehicle devices implement a self-diagnostic function (DIAG), a debag function, and the like through communication via an in-vehicle network, for example.

On the other hand, such a configuration causes a disadvantage that a possibility that vehicles undergo threats caused by cyberattacks occurs, and security measures are essential. Accompanied by promotion of Connected Autonomous Shared & Services Electric (CASE) of vehicles, it is essential to analyze and manage security risks by threat analysis of cyberattacks against vehicles in the initial stage of the vehicle development process in accordance with “UNR155”, which is the standard of the United Nations for vehicle cyber security measures formulated in the World Forum for Harmonization of Vehicle Regulations (WP29), or “ISO/SAE 21434”, which is the international standard which defines cyber security measures for the entire life cycle of vehicles.

For this reason, vulnerability analysis of vehicles is performed in the development process, security risks are analyzed and managed based on the risks revealed by the threat analysis, and appropriate countermeasures are formulated. The working amount of the vulnerability analysis has been increased due to higher functions of products and increasing attack methods. Since analysis, formulation of countermeasures, and the like should be performed in a limited development period, there is a limitation in performing analysis, formulation of countermeasures, and the like by human power.

Thus, automatic output of countermeasures through information processing using a computer or the like has been examined. When analysis, formulation of countermeasures, and the like are performed by human power, it is afraid that consistency of the relation between a security risk and its countermeasure is not guaranteed. However, such a concern is reduced by using a computer or the like. Since the countermeasure is varied depending on the type of vehicle, an OEM partner (demand or preference of the OEM partner), the product, and the like, it is desired that the computer or the like outputs appropriate information for determining the countermeasure.

For example, an analyst who determines the countermeasure may determine a countermeasure to be used from a plurality of countermeasures presented. In such a case, presentation of appropriate information for determining the countermeasure to be adopted is desired. However, in the technique disclosed in PTL 1, appropriate information for determining the countermeasure to be adopted may not be output in some cases.

Then, the present inventors have conducted extensive research about a threat analysis method and the like that can output appropriate information for determining a countermeasure, and have devised a threat analysis method and the like described below.

The threat analysis method according to one aspect of the present disclosure is a threat analysis method to be executed in a threat analysis system that presents a countermeasure against a threat of a cyberattack on a monitored object based on an analysis result of the cyberattack, the threat analysis method including: obtaining a threat analysis result after analysis of the threat of the cyberattack on the monitored object; determining a plurality of countermeasures against the threat based on the threat analysis result; determining degrees of recommendation of the plurality of countermeasures determined, based on an adoption database containing adoption results of the plurality of countermeasures from a past; and outputting the plurality of countermeasures determined in association with the degrees of recommendation, and presenting the plurality of countermeasures to a user.

Thereby, the degree of recommendation output in association with the countermeasure can be the degree according to the adoption result of the countermeasure. In other words, the degrees of recommendation can be output according to the adoption results from the past. Thus, the threat analysis method according to according to one aspect of the present disclosure can output appropriate information for determining a countermeasure.

For example, provisional degrees of recommendation of the plurality of countermeasures may be determined based on the threat analysis result, and the degrees of recommendation may be determined by correcting the provisional degrees of recommendation based on the adoption database.

Thereby, the degree of recommendation according to the adoption result of the countermeasure can be determined only by correcting the provisional degree of recommendation.

For examples, when the adoption database contains an adoption result indicating that one countermeasure of the plurality of countermeasures was adopted in the past, a provisional degree of recommendation of the one countermeasure may be corrected to make a degree of recommendation of the one countermeasure greater than a degree of recommendation of the one countermeasure in a case where the adoption database contains an adoption result indicating that the one countermeasure was not adopted in the past.

Thereby, because the countermeasure with an adoption result indicating that it was adopted in the past has a greater degree of recommendation, information that can facilitate determination of the countermeasure by the analyst can be output.

For example, when the adoption database contains the adoption result indicating that the one countermeasure was adopted in the past, the degree of recommendation of the one countermeasure may be determined by adding a first correction value to the provisional degree of recommendation, and when the adoption database contains the adoption result indicating that the one countermeasure was not adopted in the past, the degree of recommendation of the one countermeasure may be determined by subtracting a second correction value from the provisional degree of recommendation.

Thereby, the degrees of recommendation reflecting the adoption result indicating that the countermeasure was adopted and the adoption result indicating that the countermeasure was not adopted can be output. For example, compared to a case where the degree of recommendation is determined using one of the adoption result indicating that the countermeasure was adopted and the adoption result indicating that the countermeasure was not adopted, more appropriate information for determining a countermeasure to be adopted can be output.

For example, the first correction value may be determined to have a greater numeric value as a number of times of adoption of the one countermeasure is larger, and the second correction value may be determined to have a greater numeric value as a number of times of non-adoption of the one countermeasure is larger.

Thereby, using a correction value weighed according to the number of times of adoption and the number of times of non-adoption, the degree of recommendation more reflecting the adoption result can be output.

For example, the adoption database may contain one or more items of information in which adoption results of countermeasures from the past, original equipment manufacturing (OEM) information indicating an OEM partner of a monitored object, and product information indicating a product as a target of attack in the monitored object are associated, the threat analysis result may contain OEM information and product information of the monitored object corresponding to the threat analysis result, and an adoption result associated with at least one of the OEM information or the product information of the monitored object corresponding to the threat analysis result may be extracted from the adoption database, and the degree of recommendation may be determined based on the adoption result extracted.

Thereby, because an adoption result associated with at least of the OEM information or the product information is used, the degree of recommendation more suitable for at least one of a customer or a product can be output.

For example, the adoption database may further contain date and time information indicating dates and times concerning adoption results, and the degree of recommendation may further be determined based on the date and time information.

Thereby, the degree of recommendation can be output according to the date and time of the adoption result. For example, the degree of recommendation reflecting a recent demand of the customer can be output.

For example, an adoption result of a countermeasure presented concerning whether the countermeasure was actually selected by the user to address the threat may be obtained, and the adoption database may be updated based on the adoption result obtained.

Thereby, the adoption result at this time can be reflected in determination of the degree of recommendation next time or thereafter. For example, even when the demand of the customer is changed, a degree of recommendation reflecting the changed demand can be output.

For example, the plurality of countermeasures may be presented in a state where a countermeasure having a greater degree of recommendation is emphasized compared to a countermeasure having a lower degree of recommendation.

Thereby, the countermeasure having a greater degree of recommendation is emphasized and presented, and thus an appropriate information for determining a countermeasure to be adopted can be presented. Presentation of such information can assist to ensure adoption of the countermeasure by the analyst according to the demand of the customer, and enables an increase in efficiency of the task of assigning the countermeasure by the analyst.

The threat analysis system according to one aspect of the present disclosure is a threat analysis system that presents a countermeasure against a threat of a cyberattack on a monitored object based on an analysis result of the cyberattack, the threat analysis system including: an obtainer that obtains a threat analysis result after analysis of the threat of a cyberattack on the monitored object; a first determiner that determines a plurality of countermeasures against the threat based on the threat analysis result; a second determiner that determines degrees of recommendation of the plurality of countermeasures determined, based on an adoption database containing adoption results of the plurality of countermeasures from a past; and an outputter that outputs the plurality of countermeasures determined in association with the degrees of recommendation, and presents the plurality of countermeasures to a user. The recording medium according to one aspect is of the present disclosure a non-transitory computer-readable recording medium having recorded thereon a program for causing a computer to execute the threat analysis method.

Thereby, the same effects as those of the threat analysis method can be obtained.

These general or specific aspects may be implemented by a system, a method, an integrated circuit, a computer program, or a computer-readable non-transitory recording medium such as a CD-ROM, or may be implemented by any combination of systems, methods, integrated circuits, computer programs, and recording media. The program may be preliminarily stored in a recording medium, or may be supplied to a recording medium through a wide communication network including the Internet.

Hereinafter, an embodiment will be specifically described with reference to the drawings.

The embodiment described below illustrates general or specific examples. Numeric values, shapes, components, arrangement positions of components and connection forms thereof, steps, order of steps, and the like shown in the embodiment below are exemplary, and should not be construed as limitations to the present disclosure. Moreover, among the components of the embodiments below, the components not described in an independent claim will be described as optional components.

The drawings are schematic views, and are not necessarily precise illustrations. Accordingly, for example, the scale is not always consistent among the drawings. In the drawings, identical referential numerals are given in substantially identical configurations, and overlapping description will be omitted or simplified.

In this specification, terms indicating relations between entities, numeric values, and ranges of numeric values are not expressions representing strict meanings, but are expressions meaning that substantially identical ranges, for example, differences of about several percentage (or about 10%) are also encompassed.

### Embodiment

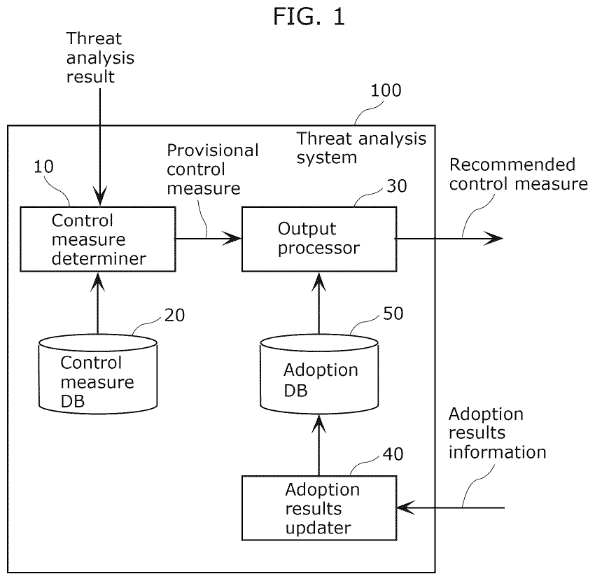

Hereinafter, the threat analysis method according to the present embodiment and the like will be described with reference to FIGS. 1 to 9.

### [1. Configuration of Threat Analysis System]

First, the configuration of the threat analysis system according to the present embodiment will be described with reference to FIGS. 1 to 5. FIG. 1 is a block diagram illustrating the functional configuration of threat analysis system 100 according to the present embodiment. Hereinafter, the countermeasure is also referred to as control measure.

As illustrated in FIG. 1, threat analysis system 100 includes control measure determiner 10, first storage 20, output processor 30, adoption results updater 40, and second storage 50. Threat analysis system 100 is an information processing system for outputting a control measure against a security risk of a mobile entity such as a vehicle in the stage of development of the mobile entity. For example, threat analysis system 100 is an information processing system for presenting a countermeasure against a threat of a cyberattack to an analyst (user) based on the results of analysis of cyberattacks on a monitored object. The monitored object may be a mobile entity itself, or may be a product (such as an in-vehicle device) provided in the mobile entity.

Control measure determiner 10 obtains the result of analysis of the threat caused by the cyberattack on the mobile entity (threat analysis result), and determines a control measure against the threat based on the obtained threat analysis result and a control measure database (DB) stored in first storage 20. The control measure determined by control measure determiner 10 is also referred to as provisional control measure. The provisional control measure contains a control measure and the degree of recommendation of the control measure. In the present embodiment, the provisional control measure contains a plurality of control measures and the degrees of recommendation of the plurality of control measures. The threat means a threat caused by a cyberattack assumed in a network within the mobile entity (such as an in-vehicle network).

Control measure determiner 10 obtains the asset classification of an asset (information asset) and information indicating a threat classification, as the threat analysis result.

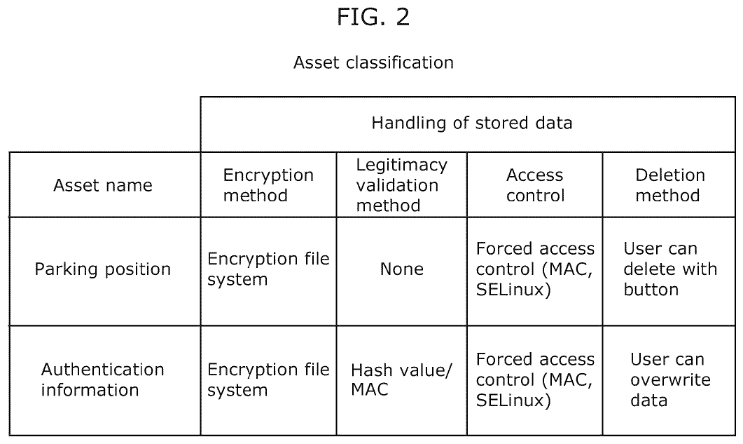

FIG. 2 is a diagram illustrating one example of the asset classification according to the present embodiment.

As illustrated in FIG. 2, the asset classification contains the asset name and handling of stored data. The asset classification can be obtained from information accompanying the asset.

The asset name is used to identify the information (asset) which is input/output from/to the network inside the mobile entity or is stored inside the mobile entity, and examples thereof include parking position, authentication information, destination information, driving trajectory, map data, control data, and sensor information. The parking position indicates information concerning the parking position, and the authentication information indicates information concerning authentication of a user or the like.

The handling of the stored data indicates the content of handling of information concerning the stored asset name, and includes an encryption method, a legitimacy validation method, access control, and a deletion method. The data is stored in a storage within the mobile entity. The information indicating the handling of the stored data is one example of attribute information of the asset.

The encryption method indicates the encryption method of encrypting information concerning the asset name. The information concerning the asset name is encrypted and stored, for example.

The legitimacy validation method indicates a method of validating information concerning the asset name.

The access control indicates a control method of protecting the information concerning the stored asset name from fraudulent access. Examples of forced access control include MAC (Mandatory access control), SELinux (Linux is a registered trademark) (Security-Enhanced Linux (registered trademark)), and the like.

The deletion method indicates a method of deleting the information concerning the stored asset name.

In the example illustrated in FIG. 2, in the handling of the stored data for the asset name “Parking position”, the encryption method is “Encryption file system”, the legitimacy validation method is “None”, the access control is “Forced access control”, and the deletion method is “User can delete with button”. In the handling of the stored data of the asset name “Authentication information”, the encryption method is “Encryption file system”, the legitimacy validation method is “Hash value/MAC (Message Authentication Code)”, the access control is “Forced access control”, and the deletion method is “User can overwrite data”.

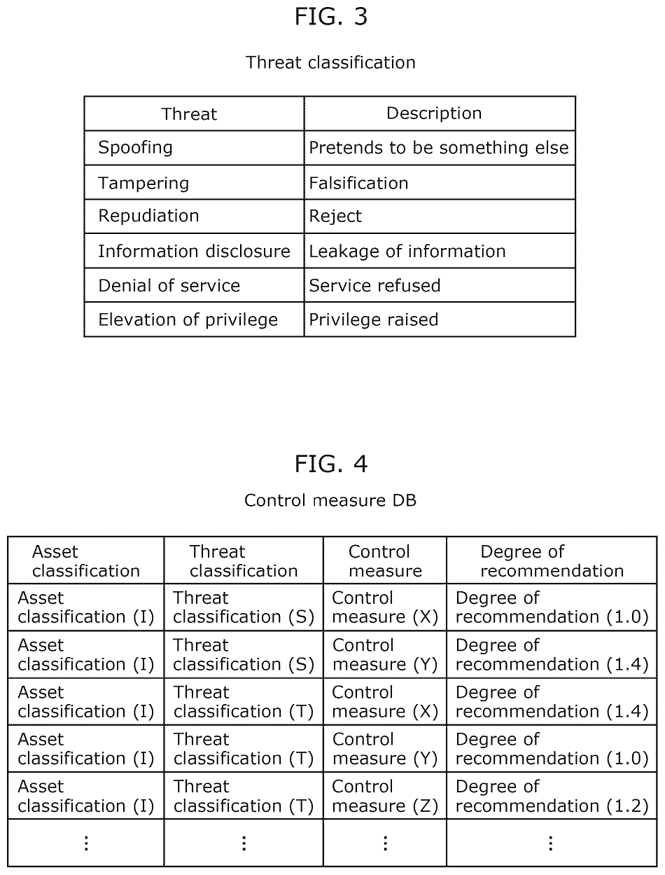

FIG. 3 is a diagram illustrating one example of the threat classification according to the present embodiment. FIG. 3 shows a list of threats. The threat is one example of the attribute information.

As illustrated in FIG. 3, the threat classification indicates the type of cyberattacks on the asset, and examples thereof include spoofing, tampering, repudiation, information disclosure, denial of service, and elevation of privilege. For example, at least one threat of spoofing, tampering, repudiation, information disclosure, denial of service, or elevation of privilege is associated with the asset name “Parking position”. The threat classification can be derived from the attack path analyzed from the data flow, examples of threats, and the like.

Again with reference to FIG. 1, first storage 20 stores information concerning known threats and countermeasures against these. First storage 20 stores a control measure DB used by control measure determiner 10 to determine a provisional measure (provisional control measure) as a control measure from the threat analysis result. First storage 20 is configured of a semiconductor memory and the like, but can have any other configuration.

The threat analysis result is a list in which the asset classification illustrated in FIG. 2 is associated with the threat classification illustrated in FIG. 3.

FIG. 4 is a diagram illustrating one example of the control measure DB according to the embodiment.

As illustrated in FIG. 4, the control measure DB indicates information (table) in which the asset classification, the threat classification, the control measure, and the degree of recommendation are associated.

The control measure indicates a measure for the asset classification and the threat classification.

The degree of recommendation indicates the degree of recommendation when the control measure is used for the asset classification and the threat classification.

Although the degree of recommendation indicates that a greater numeric value means a higher degree of recommendation, it may be set that a lower numeric value means a higher degree of recommendation. The degree of recommendation is one example of the degree of recommendation. The degree of recommendation may be set as levels of “High”, “Middle”, and “Low” rather than the numeric value.

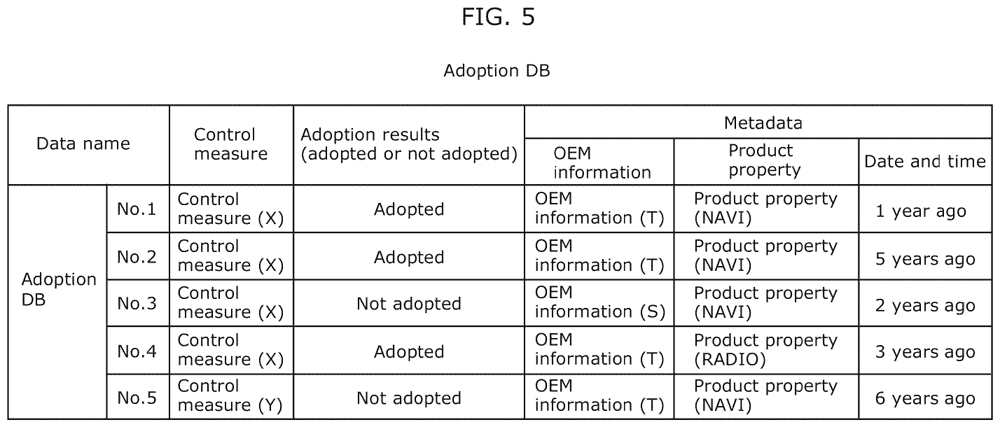

Output processor 30 performs processing according to the adoption results contained in the adoption DB stored in second storage 50 (see FIG. 5 described later) on the provisional control measure from control measure determiner 10, and outputs the provisional control measure after the processing as a recommended control measure. As the processing, output processor 30 determines the degrees of recommendation of the control measures contained in the provisional control measure according to the adoption results of the control measures. In the present embodiment, as the processing, output processor 30 updates the degrees of recommendation of the control measures contained in the provisional control measure, according to the adoption results. The adoption DB contains information indicating whether each of the control measures was adopted or not. The adoption DB may further contain metadata of each control measure.

For example, output processor 30 may output the recommended control measure on a display device (not illustrated) connected to threat analysis system 100, thereby displaying the recommended control measure on the display device, or may transmit the recommended control measure to another device through wireless communication or wired communication. Thereby, output processor 30 can display the recommended control measure on the display device. Note that the displaying is one example of presenting. The presenting may be output of a sound, for example.

After output processor 30 outputs a plurality of control measures and the degrees of recommendation of the control measures, for example, an analyst adopts one of the control measures. The control measure adopted here is a control measure according to the type of mobile entity, the demand of the OEM partner (customer), and the like. The degree of recommendation is used by the analyst as a reference for selecting the control measure.

Adoption results updater 40 obtains adoption results information via an acceptor (not illustrated) from the analyst, the adoption results information indicating which control measure was adopted among the recommended control measures. For example, the adoption results information contains information indicating both control measures which were adopted and those which were not adopted in the recommended control measures. The acceptor may be an operational device such as a button or a keyboard, may be a sound collecting device such as a microphone, or may be a communication circuit. The adoption results information may further contain metadata of each control measure.

Then, adoption results updater 40 updates the adoption DB based on the adoption results information. Specifically, adoption results updater 40 adds the obtained adoption results information to the adoption DB.

Second storage 50 stores an adoption DB used by output processor 30 to generate the recommended control measures from the provisional control measure. The adoption DB is a database of accumulated items of data (adoption results) of adopted control measures. Second storage 50 is configured of a semiconductor memory and the like, but can have any other configuration.

FIG. 5 is a diagram illustrating one example of the adoption DB according to the present embodiment.

As illustrated in FIG. 5, the adoption DB indicates information (table) in which the data name, the control measure, the adoption result, and the metadata are associated.

The data name indicates identification information for identifying a set of the control measure, the adoption result, and the metadata.

The control measure indicates the type of control measure. FIG. 5 illustrates an example in which two types of control measures, i.e., control measure (X) and control measure (Y) are contained as the control measures.

The adoption results indicate results whether the control measures output by threat analysis system 100 in the past as recommended control measures are adopted or not.

The metadata is information that affects the relation between the control measure and the adoption result, and for example, contains information concerning the customer, the product (in-vehicle device), and the like. For example, when the control measures are the same and the metadata contents are different, the adoption results may also be different. FIG. 5 illustrates an example in which the metadata contains OEM information and a product property of the target product to be protected by the control measure and the date and time concerning the adoption result (such as the date and time when the information indicating adoption/non-adoption has been obtained). It is sufficient that the metadata contains at least one of the OEM information or the product property. The product property is one example of the product information, and the date and time is one example of the date and time information.

The OEM information (T) indicates that the OEM partner is T Company, and the OEM information(S) indicates that the OEM partner is S Company. Product property (NAVI) indicates a navigation device, and product property (RADIO) indicates a radio.

### [2. Operation of Threat Analysis System]

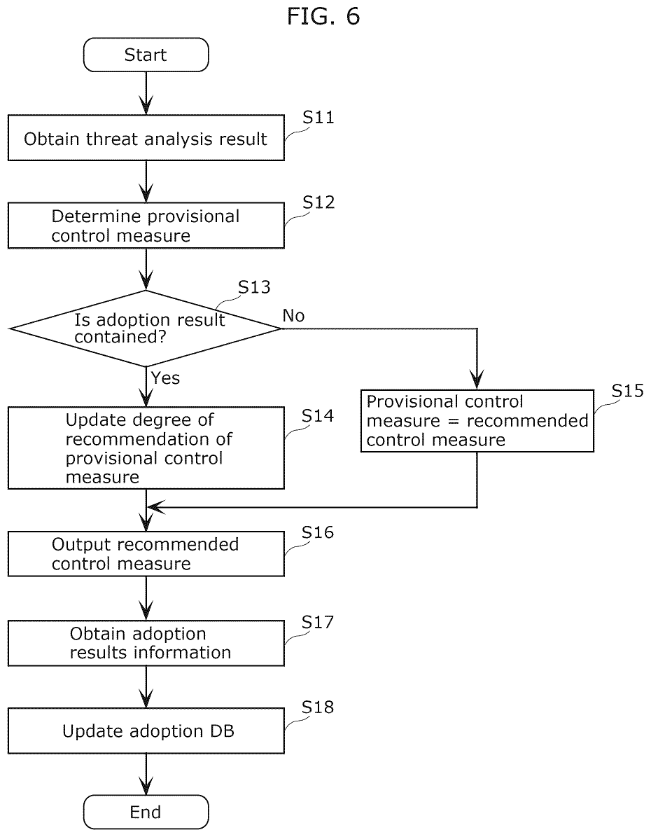

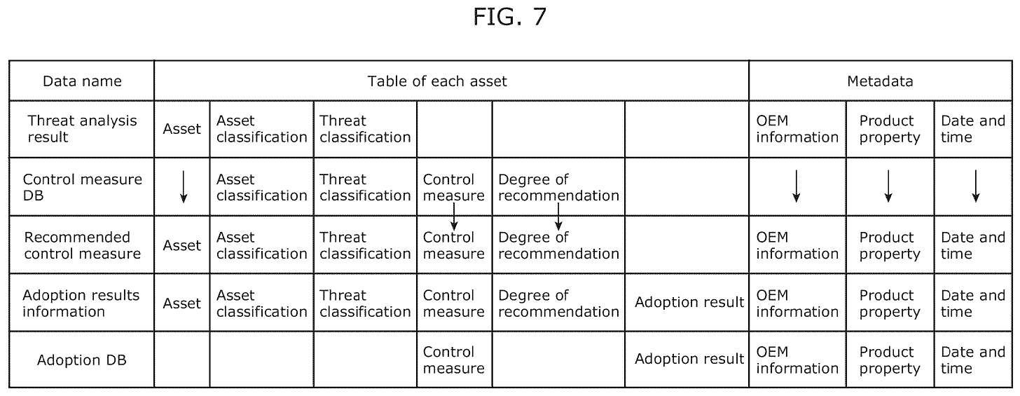

The operation of threat analysis system 100 having the above-mentioned configuration will be described with reference to FIGS. 6 to 9. FIG. 6 is a flowchart illustrating the operation of threat analysis system 100 according to the present embodiment (threat analysis method). FIG. 7 is a diagram illustrating a flow of a variety of items of data according to the present embodiment.

As illustrated in FIG. 6, control measure determiner 10 obtains a threat analysis result by an input from an external server apparatus or an analyst (S11). As illustrated in FIG. 7, control measure determiner 10 obtains an asset, an asset classification, a threat classification, and metadata as a threat analysis result. Control measure determiner 10 functions as an obtainer.

Again with reference to FIG. 6, next, control measure determiner 10 determines a provisional control measure containing one or more control measures against the threat based on the threat analysis result and the control measure DB (S12). Control measure determiner 10 extracts the control measure and degree of recommendation associated with the asset classification and the threat classification from the control measure DB, and outputs the extracted control measure and degree of recommendation to output processor 30 as a provisional control measure. A single control measure and a single degree of recommendation may be extracted, or a plurality of control measures and a plurality of degrees of recommendation may be extracted. The degree of recommendation extracted in step S12, i.e., the degree of recommendation contained in the provisional control measure is one example of the provisional degree of recommendation. Hereinafter, the degree of recommendation contained in the provisional control measure is also referred to provisional degree of recommendation for identification in some cases. Control measure determiner 10 functions as a first determiner. The metadata is not used in determination of the provisional control measure.

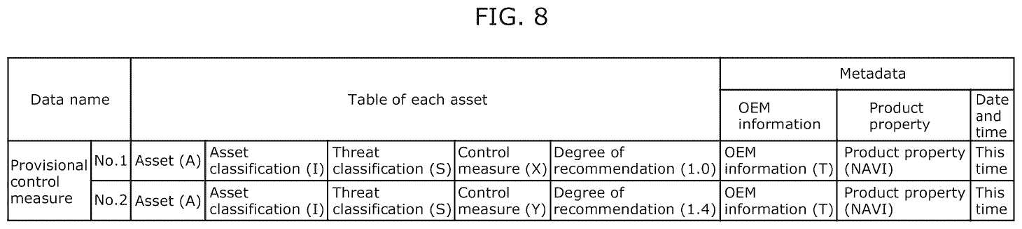

FIG. 8 is a diagram illustrating one example of the provisional control measure according to the present embodiment. FIG. 8 illustrates the provisional control measure when the asset classification is (I) and the threat classification is(S).

As illustrated in FIG. 8, the provisional control measure contains control measure (X) and its degree of recommendation (1.0) and control measure (Y) and its degree of recommendation (1.4) as the control measures and the degrees of recommendation when the asset classification is (I) and the threat classification is (S). When the asset classification is (I) and the threat classification is (S), the degree of recommendation of control measure (X) is greater than that for control measure (Y).

The provisional control measure may contain information indicating a technical requirement, a software requirement, and a hardware requirement for the measure. The degree of recommendation may not be contained in the provisional control measure. For example, it is sufficient that in step S12, at least a countermeasure is determined based on the threat analysis result.

Again with reference to FIG. 6, next, output processor 30 determines whether past results (adoption results) of the control measures contained in the provisional control measure are present or not (S13). Output processor 30 performs determination in step S13 according to whether the adoption DB contains an adoption result associated with the control measure contained in the provisional control measure.

In the case of FIG. 8, output processor 30 determines whether the adoption DB contains the adoption results of the control measures associated with control measures (X) and (Y). For example, output processor 30 may determine whether an adoption result associated with control measure (X) and the metadata corresponding to control measure (X) is contained and whether an adoption result associated with control measure (Y) and the metadata corresponding to control measure (Y) is contained. In other words, the metadata may be used in the determination in step S13. The association with the metadata encompasses association with at least one of the OEM information or the product property.

Again with reference to FIG. 6, next, when output processor 30 determines that the adoption results are contained (Yes in S13), output processor 30 updates the degree of recommendation of the provisional control measure (degrees of recommendation of the control measures) based on the adoption DB (S14). Output processor 30 determines the degree of recommendation (degree of recommendation contained in the recommended control measure) by correcting the provisional degree of recommendation based on the adoption DB. For example, when an adoption result indicating that the control measure was adopted is contained, output processor 30 corrects the degree of recommendation to make the degree of recommendation greater than that when an adoption result indicating that the control measure was not adopted is contained. For example, output processor 30 updates to increase the degree of recommendation of the control measure when the adoption result of adoption is contained or the number of times of adoption is larger, and updates to reduce the degree of recommendation when the adoption result of adoption is not contained or the number of times of adoption is smaller. The update of the degree of recommendation is one example of the determination of the degree of recommendation. Output processor 30 functions as a second determiner.

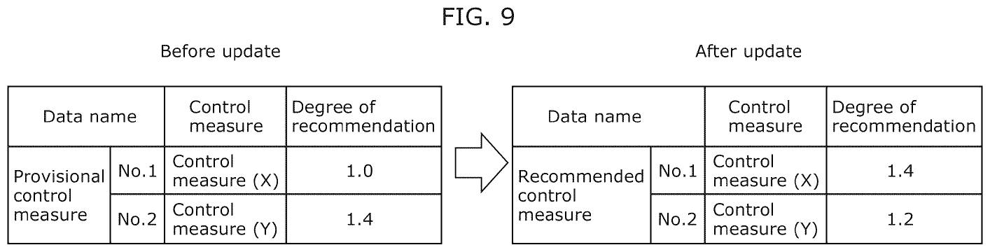

Here, update of the degree of recommendation will be described with reference to FIG. 9, in which the provisional control measure is the provisional control measure illustrated in FIG. 8 and the adoption DB is the adoption DB illustrated in FIG. 5. FIG. 9 is a diagram for illustrating the update of the degree of recommendation according to the present embodiment. An example is illustrated in which 0.2 is added to the degree of recommendation for every adoption result “Adopted” and 0.2 is subtracted from the degree of recommendation for every adoption result “Not adopted”.

“Before update” illustrated in FIG. 9 shows the control measure and degree of recommendation of the provisional control measure illustrated in FIG. 8.

When output processor 30 updates the provisional degree of recommendation, output processor 30 extracts the control measures corresponding to the provisional degree of recommendation and the adoption results associated with the metadata from the adoption DB, and updates the degree of recommendation according to the number of times of “Adopted” and “Not adopted” in the extracted adoption results.

For example, in the case of control measure (X), the OEM information in the metadata is OEM information (T), the product property is product property (NAVI). Output processor 30 extracts the adoption results with control measure (X), and OEM information (T), and product property (NAVI) from the adoption DB. In the case of FIG. 5, output processor 30 extracts adoption results Nos. 1 and 2. Since adoption results Nos. 1 and 2 are both “Adopted”, output processor 30 adds 0.4 (0.2+0.2) to the degree of recommendation of control measure (X) in the provisional control measure. In other words, output processor 30 updates the degree of recommendation of control measure (X) from “1” to “1.4”.

The added value of 0.4 is one example of a first correction value. Thus, output processor 30 may determine the first correction value to have a greater numeric value as the number of times of adoption of the control measure is larger. When an adoption result indicating that the control measure was adopted is contained or the number of times of non-adoption is larger than a predetermined number, output processor 30 may determine the degree of recommendation by adding the first correction value to the provisional degree of recommendation.

In data No. 3 contained in the adoption DB, the OEM information is different from that in control measure (X) above, and in data No. 4 contained in the adoption DB, the product property is different from that in control measure (X) above. Thus, the adoption results in adoption DB Nos. 3 and 4 are not used in the update of the degree of recommendation of control measure (X).

For example, in the case of control measure (Y) contained in the provisional control measure, the OEM information in the metadata is OEM information (T), and the product property is product property (NAVI). Output processor 30 extracts the adoption results with control measure (Y), OEM information (T), and product property (NAVI) from the adoption DB. In the case of FIG. 5, output processor 30 extracts adoption result No. 5. Since adoption result No. 5 is “Not adopted”, output processor 30 subtracts 0.2 from the degree of recommendation of control measure (Y) in the provisional control measure. In other words, output processor 30 updates the degree of recommendation of control measure (Y) from “1.4” to “1.2”.

The subtracted value of 0.2 is one example of a second correction value. Thus, output processor 30 may determine the second correction value to have a greater numeric value as the number of times of non-adoption in the control measure is larger. When an adoption result indicating that the control measure was not adopted is contained or the number of times of non-adoption is larger than a predetermined number, output processor 30 may determine the degree of recommendation by subtracting the second correction value from the provisional degree of recommendation.

Thereby, output processor 30 can update the degree of recommendation determined based on the threat analysis result to a degree of recommendation in consideration of the adoption results from the past. For similar products or products of the same customer, output processor 30 can further increase the degree of recommendation of the control measure with adoption results indicating that it was adopted.

The adoption DB may further contain date and time information indicating the date and time as the metadata, and output processor 30 may further determine the degree of recommendation based on the date and time information. For example, output processor 30 may determine the first correction value to increase the first correction value as the date and time are closer. Output processor 30 may perform weighed addition of the first correction value according to the date and time.

Again with reference to FIG. 6, when output processor 30 determines that adoption results are not contained (No in S13), output processor 30 determines the provisional control measure as the recommended control measure because there is no information used in update of the provisional degree of recommendation (S15). Here, the recommended control measure contains the provisional degree of recommendation as the degree of recommendation.

Next, output processor 30 outputs the recommended control measure (S16). Thereby, for example, output processor 30 can output one or more determined countermeasures in association with the degrees of recommendation, and can present the countermeasures to the user. Output processor 30 functions as an outputter.

When the recommended control measure is output, for example, an image for determining a control measure to be adopted is displayed on a display device used by the analyst. For example, the control measure and the degree of recommendation may be displayed on the display device. When the recommended control measure contains a plurality of control measures and degrees of recommendation, the plurality of control measures may be displayed on the display device in a state where control measures having a greater degree of recommendation are emphasized compared to those having a lower degree of recommendation. In other words, output processor 30 may output the recommended control measure containing information for displaying control measures having a greater degree of recommendation more emphasized than those having a lower degree of recommendation.

For example, the display of the control measure emphasized may indicate that the control measure having a greater degree of recommendation is displayed on an upper side of the screen, or the control measure having a greater degree of recommendation is displayed in a different display mode. For example, the control measure having a greater degree of recommendation may be displayed with larger characters, may be displayed with characters of a color different from those of other control measures, or may be displayed with blinking characters.

Among the control measures assigned to the threat, the preference order of control measures to be adopted may be varied by the OEM partner or the developed product. For this reason, the preference order of the control measures according to the situation should be presented. For this reason, threat analysis system 100 should present information containing the preference order of control measures on the display device according to the situation. Since output processor 30 updates the degree of recommendation using the adoption results, the metadata, and the like, threat analysis system 100 according to the present embodiment can present information containing the preference order of control measures on the display device according to the adoption results, the metadata, and the like.

Then, the analyst determines the control measure to be adopted. Since the analyst determines the control measure with reference to the degree of recommendation in consideration of the demand of the customer, the product, and the like, a variation in interpretation of the analysis result among analysts can be suppressed, and the task of assigning the control measure can be efficiently performed.

After the analyst determines the control measure to be adopted, using an input device, the analyst inputs adoption results information containing an adoption result indicating whether the control measured was adopted or not. In other words, adoption results updater 40 obtains adoption results information from the analyst (S17), the adoption results information containing the adoption result of the recommended control measure output in step S16. As illustrated in FIG. 7, the adoption results information contains adoption results in addition to the asset, the asset classification, the threat classification, the control measure, the degree of recommendation, and the metadata. The adoption result is information concerning whether the analyst has actually selected the recommended control measure output (e.g., displayed) in step S16 to address the threat. The adoption results information may be information of recommended control measures with adoption results added. Adoption results updater 40 functions as an obtainer that obtains the adoption results information. Thus, threat analysis system 100 is configured such that the adoption results information for the recommended control measure is fed back.

Again with reference to FIG. 6, next, adoption results updater 40 updates the adoption DB based on the adoption results information (S18). Adoption results updater 40 updates the adoption DB, for example, by associating the control measure, the adoption result, and the metadata contained in the adoption results information and adding these to the adoption DB.

Thereby, the adoption DB can be updated using the real adoption results, and thus the result from the adoption result at this time can be reflected in next determination of the degree of recommendation of a recommended control measure.

### Other Embodiments

Although the threat analysis method and the like according to one or more aspects have been described according to the embodiment, the present disclosure is not limited to this embodiment. The present disclosure may also cover embodiments obtained from a variety of modifications of the present embodiment conceived by persons skilled in the art, and those configured with a combination of components in different embodiments without departing from the gist of the present disclosure.

For example, an example in which “Adopted” and “Not adopted” are both contained as the adoption results of the adoption DB has been described in the above embodiment. However, at least one of “Adopted” or “Not adopted” may be contained.

In the above embodiment, an example in which the output processor updates the degree of recommendation (provisional degree of recommendation) determined by the control measure determiner has been described, but any other configuration can be used. The output processor may newly determine a degree of recommendation based on the adoption DB. The output processor may determine the degree of recommendation of the control measure, for example, such that the degree of recommendation is greater as the number of times of “Adopted” is larger in the adoption result corresponding to the control measure.

In the above embodiment, an example in which the threat analysis result contains the asset classification and the threat classification has been described, but any other configuration can be used, and a different condition may be contained instead of at least one of the asset classification or the threat classification or in addition to the asset classification and the threat classification. Then, the provisional control measure may be determined also using the different condition.

The adoption results information according to the above embodiment may further contain at least one of the frequency of adoption of the control measure adopted, the number of times of adoption, the proportion of adoption, the attribute of the product, customer information, or examples of threats and measures in general. The degree of recommendation may be updated using the at least one.

In the above embodiment, an example in which the mobile entity is a vehicle has been described. However, the mobile entity can be a mobile entity wirelessly communicable with an external device, and may be a mobile (e.g., autonomous mobile) robot, a flying entity such as a drone, or a railroad train.

When a plurality of control measures and a plurality of degrees of recommendation are determined, the output processor according to the above embodiment may select one or more control measures and degrees of recommendation from the plurality of control measures and the plurality of degrees of recommendation, and may output only the selected one or more control measures and degrees of recommendation. For example, the output processor may output only control measures having a degree of recommendation equal to or greater than a predetermined degree of recommendation and the degrees of recommendation of the control measures.

In the above embodiment, the output processor may extract the adoption result of the same control measure as that contained in the provisional control measure, from the adoption DB, and may determine the degree of recommendation of the control measure according to the extracted adoption result. In other words, the adoption results may be extracted without using the metadata.

In FIG. 6 above, an example in which the adoption DB is updated has been described. However, update of the adoption DB need not be performed.

In the above embodiment, the components may be each configured of dedicated hardware, or may be implemented by executing software programs suitable for the components. The components may be implemented by a program executor, such as a CPU or a processor, which reads out and executes software programs recorded on a recording medium such as a hard disk or semiconductor memory.

The order of the steps executed in the flowchart is illustrative for specific description of the present disclosure, and the steps can be executed in any other order than the above order. Moreover, part of the above steps may be executed simultaneously (concomitantly) with another step, or part of the above steps need not to be executed.

The division of the functional blocks in the block diagram is one example, and a plurality of functional blocks may be implemented as one functional block, one functional block may be divided into several functional blocks, or part of the functions may be distributed to another functional block. The functions in a plurality of functional blocks having similar functions may be processed concomitantly or in a time-sharing manner by a single item of hardware or software.

The threat analysis system according to the above embodiment may be implemented as a single device, or may be implemented by a plurality of devices. When the threat analysis system is implemented by a plurality of devices, the components included in the threat analysis system may be distributed into the plurality of devices in any manner. When the threat analysis system is implemented by a plurality of devices, the communication method among the plurality of devices is not particularly limited, and may be wireless communication, or may be wired communication. Between devices, wireless communication and wired communication may be used in combination.

Alternatively, the components described in the above embodiment may be implemented as software, or may be implemented, typically, as LSI, which is an integrated circuit. These may be individually formed into a single chip, or part or all of the components may be formed into a single chip to include these. Here, LSI is described as one example. Depending on the difference in integration density, the integrated circuit may also be referred to as IC, system LSI, super LSI, or ultra LSI in some cases. The formation of the integrated circuit is not limited to LSI, and the integrated circuit may be implemented by a dedicated circuit (e.g., a general-purpose circuit that executes dedicated programs) or a general-purpose processor. A FIGeld Programmable Gate Array (FPGA) which is programmable after manufacturing of LSI or a reconfigurable processor which enables s reconfiguration of connection or setting of circuit cells within LSI after manufacturing of the LSI may also be used. Further, if an integrated circuit forming technique replacing LSI due to progress of the semiconductor technique or another technique derived therefrom appears, naturally, the integration of components may be performed using the technique.

The system LSI is super-multifunctional LSI manufactured by integrating a plurality of processors on a single chip, and specifically is a computer system having a configuration including a microprocessor, a read only memory (ROM), a random access memory (RAM), and the like. The ROM stores a computer program. The microprocessor operates according to the computer program, and thereby the system LSI achieves the functions.

One aspect of the present disclosure may be a computer program for causing a computer to execute characteristic steps included in the threat analysis method illustrated in FIG. 6.

For example, the program may be a program to be executed by a computer. Alternatively, one aspect of the present disclosure may be a non-transitory computer-readable recording medium on which such a program is recorded. For example, such a program may be recorded on a recording medium, which may be distributed or circulated. For example, a distributed program is provided in a device including another processor, and is executed by the processor. This can cause the device to perform the processings described above.

Hereinafter, characteristics of the threat analysis method, the threat analysis system, and the recording medium described based on the above embodiment will be shown.

### <Technique 1>

A threat analysis method to be executed in a threat analysis system that presents a countermeasure against a threat of a cyberattack on a monitored object based on an analysis result of the cyberattack, the threat analysis method including:
obtaining a threat analysis result after analysis of the threat of the cyberattack on the monitored object;
determining a plurality of countermeasures against the threat based on the threat analysis result;
determining degrees of recommendation of the plurality of countermeasures determined, based on an adoption database containing adoption results of the plurality of countermeasures from a past; and
outputting the plurality of countermeasures determined in association with the degrees of recommendation, and presenting the plurality of countermeasures to a user.

### <Technique 2>

The threat analysis method according to technique 1, including:
determining provisional degrees of recommendation of the plurality of countermeasures, based on the threat analysis result; and
determining the degrees of recommendation by correcting the provisional degrees of recommendation based on the adoption database.

### <Technique 3>

The threat analysis method according to technique 2,
wherein when the adoption database contains an adoption result indicating that one countermeasure of the plurality of countermeasures was adopted in the past, a provisional degree of recommendation of the one countermeasure is corrected to make a degree of recommendation of the one countermeasure greater than a degree of recommendation of the one countermeasure in a case where the adoption database contains an adoption result indicating that the one countermeasure was not adopted in the past.

### <Technique 4>

The threat analysis method according to technique 3,
wherein when the adoption database contains the adoption result indicating that the one countermeasure was adopted in the past, the degree of recommendation of the one countermeasure is determined by adding a first correction value to the provisional degree of recommendation, and when the adoption database contains the adoption result indicating that the one countermeasure was not adopted in the past, the degree of recommendation of the one countermeasure is determined by subtracting a second correction value from the provisional degree of recommendation.

### <Technique 5>

The threat analysis method according to technique 4,
wherein the first correction value is determined to have a greater numeric value as a number of times of adoption of the one countermeasure is larger, and
the second correction value is determined to have a greater numeric value as a number of times of non-adoption of the one countermeasure is larger.

### <Technique 6>

The threat analysis method according to any one of techniques 2 to 5,
wherein the adoption database contains one or more items of information in which adoption results of countermeasures from the past, original equipment manufacturing (OEM) information indicating an OEM partner of a monitored object, and product information indicating a product as a target of attack in the monitored object are associated,
the threat analysis result contains OEM information and product information of the monitored object corresponding to the threat analysis result, and
an adoption result associated with at least one of the OEM information or the product information of the monitored object corresponding to the threat analysis result is extracted from the adoption database, and the degree of recommendation is determined based on the adoption result extracted.

### <Technique 7>

The threat analysis method according to technique 6,
wherein the adoption database further contains date and time information indicating dates and times concerning adoption results, and
the degree of recommendation is further determined based on the date and time information.

### <Technique 8>

The threat analysis method according to any one of techniques 1 to 7,
wherein an adoption result of a countermeasure presented concerning whether the countermeasure was actually selected by the user to address the threat is obtained, and
the adoption database is updated based on the adoption result obtained.

### <Technique 9>

The threat analysis method according to any one of techniques 1 to 8,
wherein the plurality of countermeasures are presented in a state where a countermeasure having a greater degree of recommendation is emphasized compared to a countermeasure having a lower degree of recommendation.

### <Technique 10>

A threat analysis system that presents a countermeasure against a threat of a cyberattack on a monitored object based on an analysis result of the cyberattack, the threat analysis system including:
an obtainer that obtains a threat analysis result after analysis of the threat of a cyberattack on the monitored object;
a first determiner that determines a plurality of countermeasures against the threat based on the threat analysis result;
a second determiner that determines degrees of recommendation of the plurality of countermeasures determined, based on an adoption database containing adoption results of the plurality of countermeasures from a past; and
an outputter that outputs the plurality of countermeasures determined in association with the degrees of recommendation, and presents the plurality of countermeasures to a user.

### <Technique 11>

A non-transitory computer-readable recording medium having recorded thereon a program for causing a computer to execute the threat analysis method according to any one of techniques 1 to 9.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2022-087544 filed on May 30, 2022, and PCT International Application No. PCT/JP2023/003579 filed on Feb. 3, 2023.

### INDUSTRIAL APPLICABILITY

The present disclosure is useful in threat analysis methods for outputting control measures against cyberattacks to mobile entities.

1. A threat analysis method to be executed in a threat analysis system that presents a countermeasure against a threat of a cyberattack on a monitored object based on an analysis result of the cyberattack, the threat analysis method comprising:
obtaining a threat analysis result after analysis of the threat of the cyberattack on the monitored object;
determining a plurality of countermeasures against the threat based on the threat analysis result;
determining degrees of recommendation of the plurality of countermeasures determined, based on an adoption database containing adoption results of the plurality of countermeasures from a past; and
outputting the plurality of countermeasures determined in association with the degrees of recommendation, and presenting the plurality of countermeasures to a user.

2. The threat analysis method according to claim 1, comprising:
determining provisional degrees of recommendation of the plurality of countermeasures, based on the threat analysis result; and
determining the degrees of recommendation by correcting the provisional degrees of recommendation based on the adoption database.

3. The threat analysis method according to claim 2,
wherein when the adoption database contains an adoption result indicating that one countermeasure of the plurality of countermeasures was adopted in the past, a provisional degree of recommendation of the one countermeasure is corrected to make a degree of recommendation of the one countermeasure greater than a degree of recommendation of the one countermeasure in a case where the adoption database contains an adoption result indicating that the one countermeasure was not adopted in the past.

4. The threat analysis method according to claim 3,
wherein when the adoption database contains the adoption result indicating that the one countermeasure was adopted in the past, the degree of recommendation of the one countermeasure is determined by adding a first correction value to the provisional degree of recommendation, and when the adoption database contains the adoption result indicating that the one countermeasure was not adopted in the past, the degree of recommendation of the one countermeasure is determined by subtracting a second correction value from the provisional degree of recommendation.

5. The threat analysis method according to claim 4,
wherein the first correction value is determined to have a greater numeric value as a number of times of adoption of the one countermeasure is larger, and
the second correction value is determined to have a greater numeric value as a number of times of non-adoption of the one countermeasure is larger.

6. The threat analysis method according to claim 2,
wherein the adoption database contains one or more items of information in which adoption results of countermeasures from the past, original equipment manufacturing (OEM) information indicating an OEM partner of a monitored object, and product information indicating a product as a target of attack in the monitored object are associated,
the threat analysis result contains OEM information and product information of the monitored object corresponding to the threat analysis result, and
an adoption result associated with at least one of the OEM information or the product information of the monitored object corresponding to the threat analysis result is extracted from the adoption database, and the degree of recommendation is determined based on the adoption result extracted.

7. The threat analysis method according to claim 6,
wherein the adoption database further contains date and time information indicating dates and times concerning adoption results, and
the degree of recommendation is further determined based on the date and time information.

8. The threat analysis method according to claim 1,
wherein an adoption result of a countermeasure presented concerning whether the countermeasure was actually selected by the user to address the threat is obtained, and
the adoption database is updated based on the adoption result obtained.

9. The threat analysis method according to claim 1,
wherein the plurality of countermeasures are presented in a state where a countermeasure having a greater degree of recommendation is emphasized compared to a countermeasure having a lower degree of recommendation.

10. The threat analysis method according to claim 2,
wherein when the adoption database does not contain an adoption result indicating that one countermeasure of the plurality of countermeasures was adopted in the past, the provisional degree of recommendation is determined as the degree of recommendation.

11. The threat analysis method according to claim 1,
wherein each of the adoption results contains at least one of an asset that is information input and output in a network inside the monitored object or stored inside the monitored object, an asset classification of the asset, a threat classification indicating a type of a cyberattack on the asset, a countermeasure, a degree of recommendation, or metadata.

12. The threat analysis method according to claim 10,
wherein each of the adoption results further contains at least one of a frequency of adoption of the countermeasure, a number of times of adoption, a proportion of adoption, an attribute of a product provided in the monitored object, customer information, or examples of threats and measures in general.

13. The threat analysis method according to claim 11,
wherein the asset contains at least one of a parking position of the monitored object, authentication information, destination information, driving trajectory, map data, control data, or sensor information.

14. The threat analysis method according to claim 1,
wherein the monitored object is a mobile entity or a product provided in the mobile entity.

15. A threat analysis system that presents a countermeasure against a threat of a cyberattack on a monitored object based on an analysis result of the cyberattack, the threat analysis system comprising:
an obtainer that obtains a threat analysis result after analysis of the threat of a cyberattack on the monitored object;
a first determiner that determines a plurality of countermeasures against the threat based on the threat analysis result;
a second determiner that determines degrees of recommendation of the plurality of countermeasures determined, based on an adoption database containing adoption results of the plurality of countermeasures from a past; and
an outputter that outputs the plurality of countermeasures determined in association with the degrees of recommendation, and presents the plurality of countermeasures to a user.

16. A non-transitory computer-readable recording medium having recorded thereon program for causing a computer to execute the threat analysis method according to claim 1.
